(19) United States
(12) Patent Application Publication
(10) Pub. No.: US 2006/0205279 A1
(43) Pub. Date: Sep. 14, 2006

(54) Electronic device and receptacle thereof

(75) Inventor: Long-Jyh Pan, Taipei County (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/370,910

(22) Filed: Mar. 9, 2006

(30) Foreign Application Priority Data
Mar. 9, 2005 (TW) 94107102

(51) Int. Cl. H01R 24/00

(52) U.S. Cl. 439/630

(57) ABSTRACT

An electronic device for electrical connection to an object, e.g. a chip or a card, comprises a base and a receptacle. The receptacle disposed on the base comprises a body, a first element having a first contact portion, a second element having a second contact portion movable between a first reference position and a second reference position, and a third element having a stopper. When the object moves the second contact portion from the first reference position to the second reference position, the object contacts the stopper and the first contact portion is positioned. When the object is released from the stopper, the second contact portion moves to the first reference position from the second reference position, and the object is separated from the first contact portion.

### BACKGROUND

The invention relates to an electronic device and receptacle thereof, and in particular to a receptacle for accessing a chip or a card in an electronic device.

Chips are conventionally installed in mobile phones. When removing the chip from the phone by fingers, particularly chips securely fixed by a receiving device of the phone, damage occurs to the user's nails.

### SUMMARY

The invention provides an electronic device using a receptacle to receive an object such as a chip or a card, so that the object is electronically connected to the electronic device. The electronic device comprises a base and a receptacle. The receptacle disposed on the base comprises a body, a first element comprising a first contact portion, a second element comprising a second contact portion moving between a first reference position and a second reference position, and a third element comprising a stopper. When the object is disposed in the receptacle, the object abuts among the first element, the second contact portion of the second element, and the stopper of the third element to position the second element in the second reference position.

When the object moves the second contact portion from the first reference position to the second reference position to make the object contacts the stopper, the object contacts the stopper, so that the object is positioned between the second element and the third element and contacts the first contact portion. The second contact portion is moved from the second reference position to the first reference position when the object is separated from the stopper, so that the object is separated from the first contact portion.

### DESCRIPTION OF THE DRAWINGS

The invention can be more fully understood by reading the subsequent detailed description and examples with references made to the accompanying drawings, wherein:

FIG. 1A is a perspective view of a receptacle (2) of the invention;

FIG. 1B is another perspective view of the receptacle (2) of the invention;

FIG. 2 is a perspective view of the receptacle (2) of the invention;

FIG. 3A is a perspective view of a chip (S) prior to being placed in an electronic device (E);

FIG. 3B is a perspective view of the chip (S) placed in the electronic device (E);

FIG. 4A is a sectional view of the electronic device (E) along line (a1-a1 of FIG. 3A;

FIG. 4B is a sectional view of the electronic device (E) along line (a2-a2) of FIG. 3B;

FIGS. 5A to 5D are four perspective views showing the steps of installation of the chip (S) in the electronic device (E).

### DETAILED DESCRIPTION

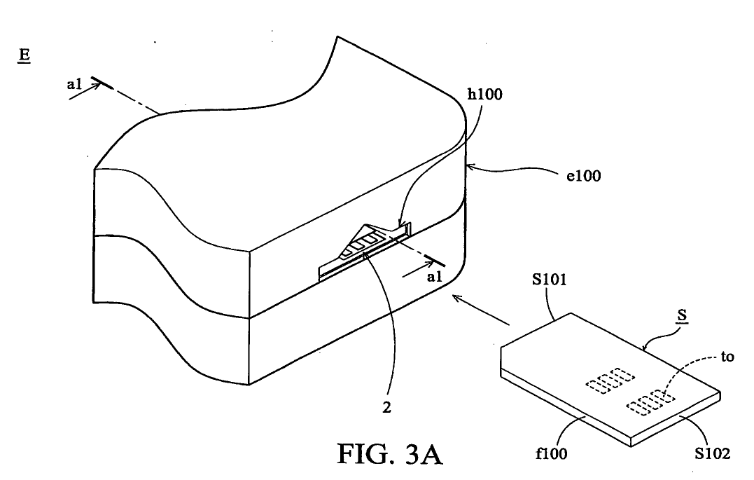

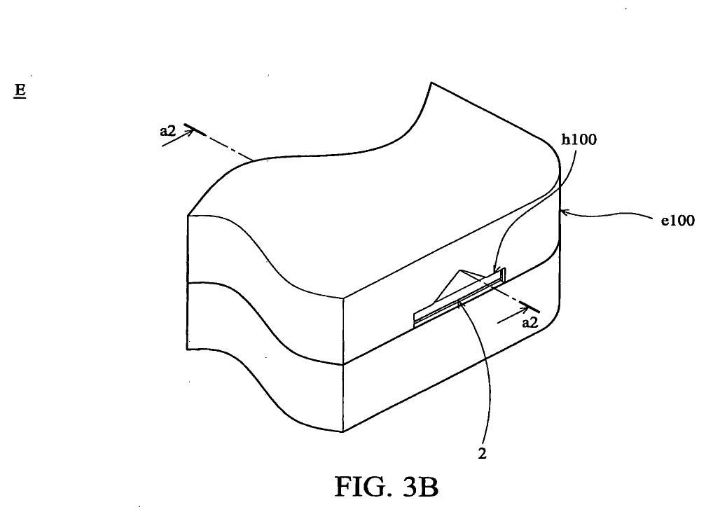

In FIGS. 3A and 3B, an exemplary electronic device E of the invention is a mobile phone, comprising a receptacle 2 receiving an object S, e.g. a chip, so that the chip S is electronically connected to the phone E. It is to be understood that the invention is not limited to a mobile phone, the receptacle 2 can be applied on different electronic devices such as Personal Digital Assistant (PDA).

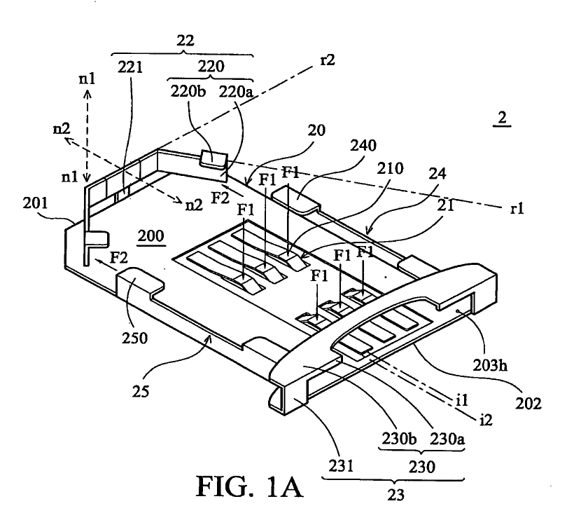

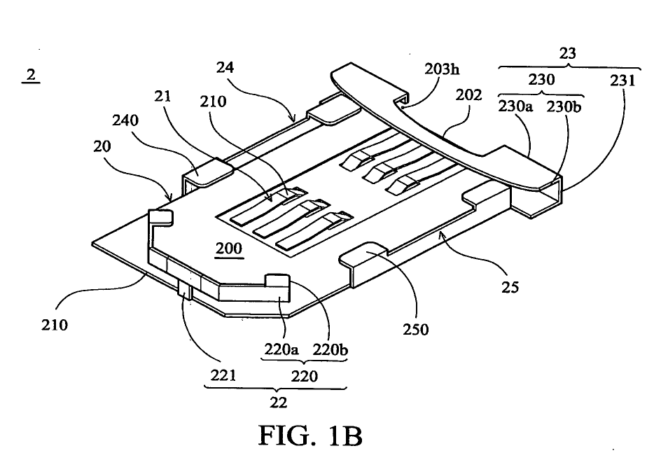

In FIGS. 1A and 1B, the receptacle 2 comprises a body 20, a plurality of first elements 21, a second element 22, a third element 23 and two guide rails 24 and 25. The body 20 comprises a base surface 200, a first side 201 and a second side 202. The first and second sides 201 and 202 disposed on two ends of the base surface 200 correspond to each other. A first direction n1 shows a normal direction of the base surface 200 and a second direction n2 substantially perpendicular to the first direction n1 shows a longitudinal direction of the body 20.

The first elements 21 are spaced cantilevered arms projecting from the base surface 200, each of which comprises a first contact portion 210. In the embodiment, the first element 21 functions as a reed.

The second element 22 disposed on the first side 201 of the body 20 comprises a second contact portion 220 and a connecting portion 221. The connecting portion 221 is disposed between the body 20 and the second contact portion 220. Each end of the second contact portion 220 comprises two segments 220a and 220b substantially in an L-shape. The segment 220a extends along a direction perpendicular to the base surface 200, and the segment 220b extends along a direction parallel to the base surface 200. In the embodiment, the second contact portion 220 of the second element 22 substantially functions as a reed.

The third element 23 corresponding to the second element 22 protrudes from the second side 202 of the body 20. The third element 23 comprises an L-shaped stopper 230 and two connecting portions 231 connecting the stopper 230 to the body 20. An access portion 230h is a rectangular opening formed among the stopper 230 and the connecting portions 231. The stopper 230 comprises a segment 230a extending along a direction perpendicular to the base surface 200 and a segment 230b extending along a direction parallel to the base surface 200, i.e., the segments 230a and 230b are perpendicular to each other.

The guide rails 24 and 25 are correspondingly disposed on two edges of the base surface 200, and two protrusions 240 and 250 respectively formed on the guide rails 24 and 25 extend along a direction parallel to the base surface 200.

In the embodiment, the first contact portion 210 of the first element 21, the second contact portion 220 of the second element 22, the stopper 230 of the third element 23 and the guide rails 24, 25 are integrally formed by a metallic sheet.

In FIG. 1A, an acting force F1 applied on the first contact portion 210 of the first element 21 along the first direction n1 moves the first contact portion 210 of the first element 21 between an initial position i1 and a predetermined position i2 along the first direction n1. When the acting force F1 is removed, the first contact portion 210 of the first element 21 is elastically returns to the initial position i1 from the predetermined position i2.

An acting force F1 applied on the second contact portion 220 of the second element 22 of the second element 22 moves the second contact portion 220 between a first reference position r1 and a second reference position r2. When the acting force F2 is removed, the second contact portion 220 is elastically returns to the first reference position r1 from the second reference position r2.

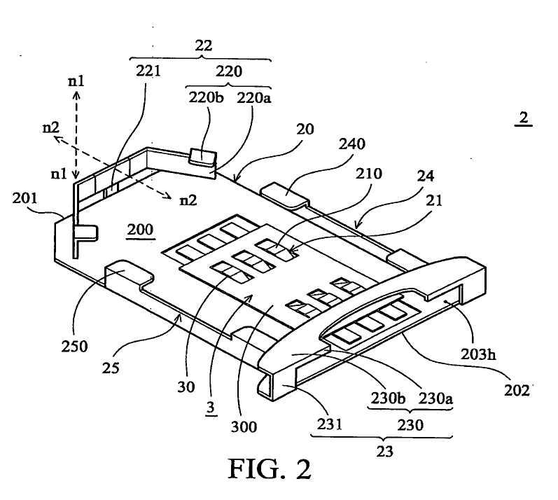

In FIG. 2, a rectangular pallet 3 supported by the first elements 21 of the receptacle 2 comprises a plurality of spaced through holes 30 corresponding to each first element 21, respectively. When the pallet 3 is disposed on the receptacle 2, the first elements 21 of the receptacle 2 are respectively received in the through holes 30, and the first contact portions 210 of the first elements 21 are located above the surface 300 of the pallet 3.

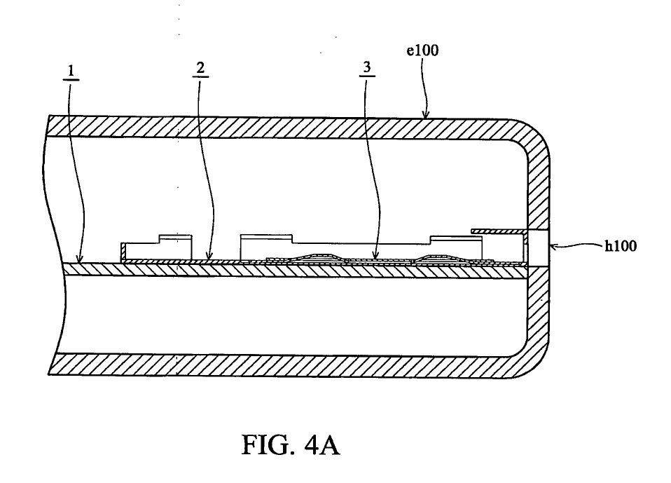

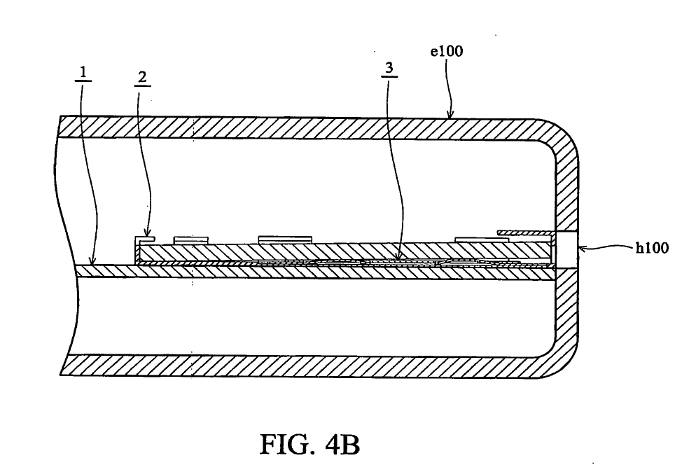

FIG. 3A shows the chip S prior to being placed in the phone E, and FIG. 3B shows the chip S placed in the phone E. FIGS. 4A and 4B are two sectional views of the phone E along lines a1-a1 and a2-a2 of FIGS. 3A and 3B, respectively.

In addition to the receptacle 2, the phone E further comprises a housing e100, a base 1 disposed in the housing e100 and an opening h100 formed on one side of the housing e100. The receptacle 2 is disposed on the base 1, and the access portion 230h to the receptacle 2 corresponds to the opening h100 of the housing e100. The chip S comprises a surface f100 and a plurality of contacts t0 formed on the surface f100 and corresponding to the first contact portion 210 of the first element 21 of the receptacle 2.

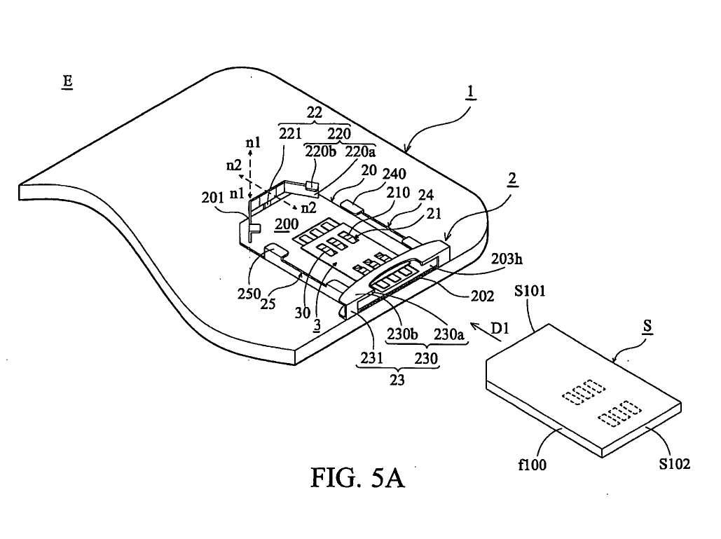

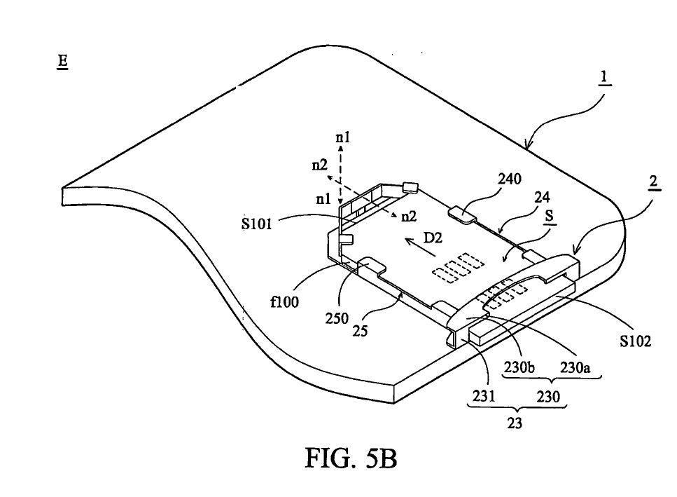

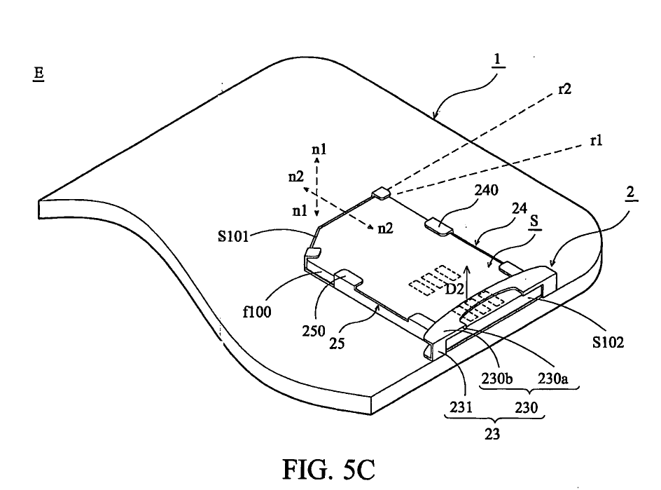

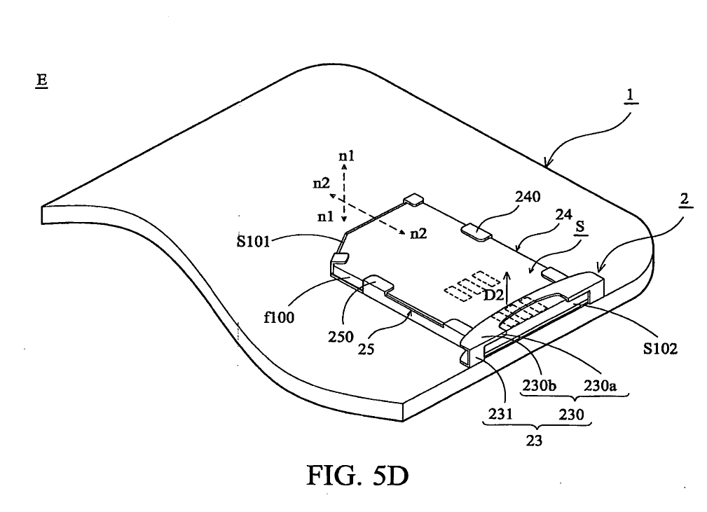

The structure of the phone E in FIGS. 5A to 5D is simplified, allowing only the relationship of the base 1, the receptacle 2 and the pallet 3.

When the chip S is inserted into the access portion 230h of the receptacle 2 along a direction D1, with the limitation of the guide rails 24/25 and the pallet 3 in FIGS. 5A and 5B, the chip S slides on the pallet 3 and the contacts t0 of the chip S correspond to the first contact portions 210 of the first element 21. The first contact portions 210 of the first element 21 exert an elastic force to impel the chip S against the pallet 3, the segment 230b of the stopper 230 and the protrusions 240, 250 of the guide rails 24 and 25. Meanwhile, with the segment 230a of the stopper 230, the chip S is prevented from slipping out of the receptacle 2 along the second direction n2. When the end s101 of the chip S contacts the second element 22, the segments 220a of each second contact portion 220 of the second element 22 elastically deforms, and the segments 220b of each second contact portion 220 of the second element 22 prevent the chip S from dislodging.

When the second contact portion 220 of the second element 22 is moved to the second reference position r2, the end s101 of the chips S completely pass the access portion 230h of the receptacle 2. With the deformed first element 21, the chip S immediately abuts the segment 230b of the stopper 230 along a direction D2 in FIG. 5C; meanwhile, with the deformed second element 22, the end s101 of the chip S abuts the other side of the segment 230a of the stopper 230.

To remove the chip S from the receptacle 2, the user only has to push the end s102 of the chip S, so that the end s101 of the chip S is separated from the stopper 230. When the end s101 of the chip S is completely disengaged from the stopper 230, the end s101 of the chip S faces the access portion 230h of the receptacle 2, and the chip S is outwardly ejected via the access portion 230h by the deformed second contact portion 220 of the second element 22, i.e., the second contact portion 220 is elastically returns to the first reference position r1 from the second reference position r2. Thus, the chip S can be removed form the receptacle 2.

While the invention has been described with respect to preferred embodiment, it is to be understood that the invention is not limited thereto, but, on the contrary, is intended to accommodate various modifications and equivalent arrangements included within the spirit and scope of the appended claims.

What is claimed is:

1. A receptacle for positioning an object, comprising:
a body comprising a first side and a second side corresponding to the first side;
a first element disposed on the body, comprising a first contact portion;
a second element disposed on the first side of the body, the second element comprising a second contact portion moving between a first reference position and a second reference position; and
a third element disposed on the second side of the body, comprising a stopper;
wherein the object abuts among the first element, the second contact portion of the second element, and the stopper of the third element, such that the second element is positioned in the second reference position when the object is disposed in the receptacle.

2. The receptacle as claimed in claim 1, wherein the object moves the second contact portion from the first reference position to the second reference position to make the object contacts the stopper, so that the object is positioned between the second element and the third element and contacts the first contact portion; the second contact portion is moved from the second reference position to the first reference position when the object is separated from the stopper, so that the object is separated from the first contact portion.

3. The receptacle as claimed in claim 1, wherein the first contact portion, the second contact portion, and the stopper are integrally formed.

4. The receptacle as claimed in claim 1, wherein the first contact portion of the first element is a cantilevered arm extending from the body.

5. The receptacle as claimed in claim 1, wherein the first contact portion of the first element moves substantially along a first direction between an initial position and a predetermined position, and the second contact portion of the second element moves substantially along a second direction between the first reference position and the second reference position, and the first direction is substantially perpendicular to the second direction.

6. The receptacle as claimed in claim 1, wherein the second contact portion of the second element comprises a cantilevered arm extended from the body.

7. The receptacle as claimed in claim 1, wherein the second contact portion of the second element is a reed.

8. The receptacle as claimed in claim 1, wherein the second contact portion of the second element is substantially in an L-shape.

9. The receptacle as claimed in claim 1, wherein the stopper of the third element is substantially in an L-shape.

10. The receptacle as claimed in claim 1 further comprising an access portion adjacent to the stopper, so that the object is placed on the receptacle or separated from the receptacle via the access portion.

11. The receptacle as claimed in claim 10, wherein the access portion comprises an opening.

12. An electronic device for electronically connecting an object, comprising:
a base; and
a receptacle disposed on the base, comprising a body, a first element comprising a first contact portion, a second element comprising a second contact portion moving between a first reference position and a second reference position, and a third element comprising a stopper;
wherein the object abuts the first element, the second contact portion of the second element and the stopper of the third element, such that the second element is positioned in the second reference position when the object is disposed in the receptacle.

13. The electronic device as claimed in claim 12, wherein the object moves the second contact portion from the first reference position to the second reference position to make the object contacts the stopper, so that the object is positioned between the second element and the third element and contacts the first contact portion; the second contact portion is moved from the second reference position to the first reference position when the object is separated from the stopper, so that the object is separated from the first contact portion.

14. The electronic device as claimed in claim 12, wherein the first contact portion, the second contact portion and the stopper are integrally formed.

15. The electronic device as claimed in claim 12, wherein the first contact portion of the first element is a cantilevered arm extending from the body.

16. The electronic device as claimed in claim 12, wherein the first contact portion of the first element moves substantially along a first direction between an initial position and a predetermined position, and the second contact portion of the second element moves substantially along a second direction between the first reference position and the second reference position, and the first direction is substantially perpendicular to the second direction.

17. The electronic device as claimed in claim 12, wherein the second contact portion of the second element comprises a cantilevered arm extended from the body.

18. The electronic device as claimed in claim 12, wherein the second contact portion of the second element is a reed.

19. The electronic device as claimed in claim 12, wherein the second contact portion of the second element is substantially in an L-shape.

20. The electronic device as claimed in claim 12, wherein the stopper of the third element is substantially in an L-shape.

21. The electronic device as claimed in claim 12 further comprising an access portion adjacent to the stopper, so that the object is placed on the receptacle or separated from the receptacle via the access portion.
